(19) United States
(12) Patent Application Publication
(10) Pub. No.: US 2026/0013663 A1
(43) Pub. Date: Jan. 15, 2026

(54) LOCKING DEVICE WITH FLIP STRUCTURE, AND BAKING PAN MACHINE

(71) Applicant: Tsann Kuen (Zhangzhou) Enterprise Co., Ltd., Zhangzhou City (CN)

(72) Inventors: Chunyu WU, Zhangzhou City (CN); Yipeng XU, Zhangzhou City (CN)

(21) Appl. No.: 19/262,442

(22) Filed: Jul. 8, 2025

(30) Foreign Application Priority Data
Jul. 15, 2024 (CN) 202421671280.4

(51) Int. Cl. A47J 37/06; A47J 36/10

(52) U.S. Cl. CPC A47J 37/0611; A47J 36/10

(57) ABSTRACT

A locking device with a flip structure includes a first main body and a second main body in flip connection with the first main body, where a rotary control member is arranged on a side edge of the first main body; a positioning protruding shaft corresponding to the rotary control member is arranged on a side edge of the second main body; a sliding groove configured to fit with the positioning protruding shaft is formed in the rotary control member; and when the rotary control member is rotated, a rotational motion of the rotary control member relative to the first main body can be converted into a flip closure motion between the first main body and the second main body through sliding fit between the positioning protruding shaft and the sliding groove, until the first main body and the second main body form a tightly closed state.

### CROSS-REFERENCE TO RELATED APPLICATIONS

This application claims priority to Chinese Patent Application 202421671280.4, filed on Jul. 15, 2024, which is incorporated herein by reference.

### TECHNICAL FIELD

The present disclosure relates to the technical field of baking pan machines, specifically to a locking device with a flip structure, and a baking pan machine.

### BACKGROUND

In an existing baking pan machine, an upper baking pan is typically in flip connection with a lower baking pan to form a main structure. When relatively soft food such as toast or bread is pan-fried and baked, the food is usually placed in the lower baking pan, and then the upper baking pan can be pressed down with some force to fit together with the lower baking pan, so that the soft food is pressed to a certain thickness and is pan-fried and baked.

However, when relatively firm food such as seafood or vegetable is pan-fried and baked, the upper baking pan on the baking pan machine needs to be pressed with considerable force to fit together with the lower baking pan, so that the food is pressed to a corresponding thickness and is pan-fried and baked. This makes the operation laborious and inefficient, thereby affecting user experience.

### SUMMARY

In view of the deficiencies in the prior art, provided in the present disclosure is a locking device with a flip structure. A first main body and a second main body in flip connection can be correspondingly closed together through rotation, which saves time and labor, and improves operational efficiency.

To achieve the above objective, the present disclosure is implemented through the following technical solution:

A locking device with a flip structure, including a first main body and a second main body in flip connection with the first main body, where a rotary control member is arranged on a side edge of the first main body; a positioning protruding shaft corresponding to the rotary control member is arranged on a side edge of the second main body; a sliding groove configured to fit with the positioning protruding shaft is formed in the rotary control member; and when the rotary control member is rotated, a rotational motion of the rotary control member relative to the first main body can be converted into a flip closure motion between the first main body and the second main body through sliding fit between the positioning protruding shaft and the sliding groove, until the first main body and the second main body form a tightly closed state.

Further, the rotary control member is rotatably connected to a front side edge of the first main body; the positioning protruding shaft is arranged at a front side edge of the second main body; the rotary control member and the positioning protruding shaft are arranged oppositely in an up-and-down manner; and rear side edges of the first main body and the second main body are configured to be movably connected through a flip connection structure.

Further, the rotary control member includes a rotary handle rotatably connected to the first main body; a rotating base opposite to the positioning protruding shaft on the second main body is fixedly connected to the rotary handle, the rotating base is configured to rotate synchronously with the rotary handle, the sliding groove is formed in an inner side surface of the rotating base corresponding to the positioning protruding shaft, and the rotating base is further provided with an opening communicating with the sliding groove; and when the first main body flips relative to the second main body to achieve closure, the positioning protruding shaft on the second main body is capable of entering the sliding groove of the rotating base through the opening.

Further, the rotary control member is configured to be capable of rotating by 90° relative to the first main body; during rotation of the rotary control member, through the sliding fit between the sliding groove and the positioning protruding shaft, the first main body is controlled to flip downward to approach the second main body to achieve closure; and when the rotary control member rotates by 90° relative to the first main body, the positioning protruding shaft abuts against a tail end of the sliding groove, and the first main body is tightly closed against the second main body.

Further, the sliding groove is in the shape of an arc-shaped long strip.

Further, the positioning protruding shaft and the second main body are of an integrally formed structure.

Further, the first main body is an upper baking pan structure of a baking pan machine, and the second main body is a lower baking pan structure of the baking pan machine.

Based on the same inventive concept, further provided in the present disclosure is a baking pan machine, including the locking device with a flip structure according to any one of the foregoing.

The above technical solution has the following advantages or beneficial effects:

In the locking device with a flip structure and the baking pan machine according to the present disclosure, the rotary control member and the positioning protruding shaft that fit with each other are arranged between the first main body and the second main body in flip connection; when the first main body and the second main body need to be closed, the rotational motion of the rotary control member relative to the first main body can be converted into the flip closure motion of the first main body relative to the second main body by rotating the rotary control member through the sliding fit between the positioning protruding shaft and the sliding groove, until the first main body and the second main body form the tightly closed state and are locked; and the closure between the first main body and the second main body saves time and labor, and is highly efficient, thereby enhancing user experience.

### BRIEF DESCRIPTION OF DRAWINGS

FIG. 1 is a schematic diagram of a three-dimensional structure of a baking pan machine in an unclosed state according to the embodiments of the present disclosure;

FIG. 2 is a schematic diagram of a three-dimensional structure of a baking pan machine in an unclosed state according to the embodiments of the present disclosure from another perspective;

FIG. 3 is a sectional view of A-A in FIG. 2;

FIG. 4 is a schematic diagram of a three-dimensional structure of a baking pan machine in a closed state according to the embodiments of the present disclosure;

FIG. 5 is a sectional view of a structure of a baking pan machine in a closed state according to the embodiments of the present disclosure; and

FIG. 6 is a schematic diagram of a three-dimensional structure of a rotary control member according to the embodiments of the present disclosure.

### DESCRIPTION OF REFERENCE NUMERALS

1. first main body; 2. second main body; 3. rotary control member; 4. positioning protruding shaft; 31. rotary handle; 32. rotating base; 321. sliding groove; and 322. opening.

### DESCRIPTION OF EMBODIMENTS

The present disclosure is further described below with reference to the accompanying drawings and embodiments.

In the description of the present disclosure, it is to be understood that the terms “upper”, “lower”, “front”, “back”, “left”, “right”, “top”, “bottom”, “inner”, “outer”, and the like indicate orientations or positional relationships based on orientations or positional relationships shown in the accompanying drawings, merely for the convenience of describing the present disclosure and simplifying the description, rather than indicating or implying that the apparatus or element referred to must have a particular orientation or be constructed and operated in a particular orientation, and therefore cannot be understood as limitations to the present disclosure.

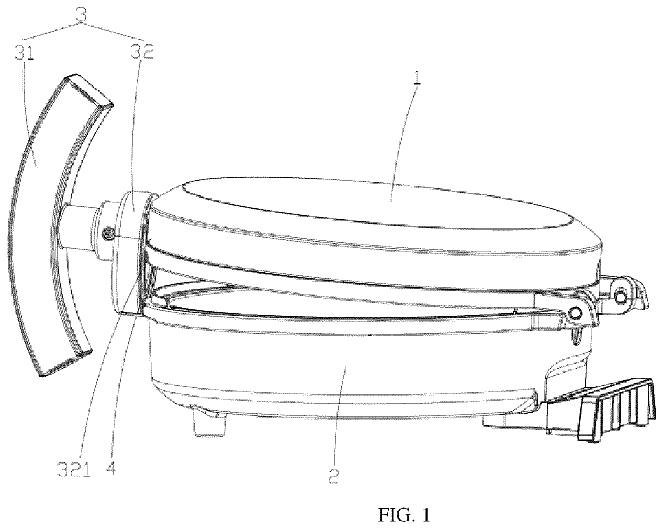

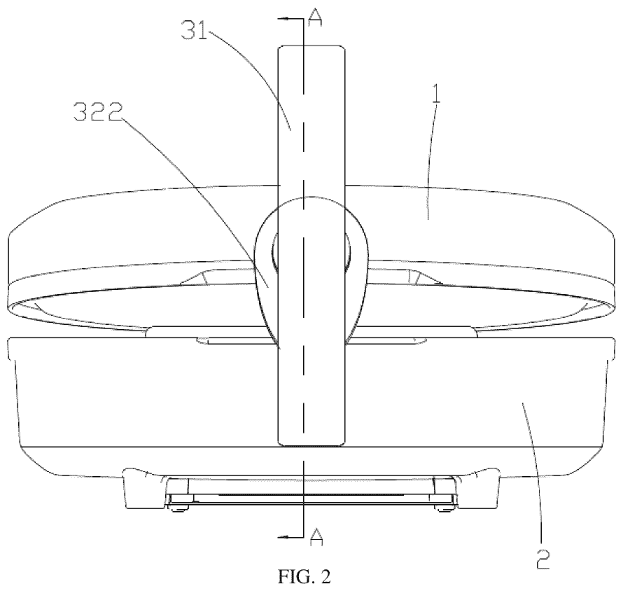

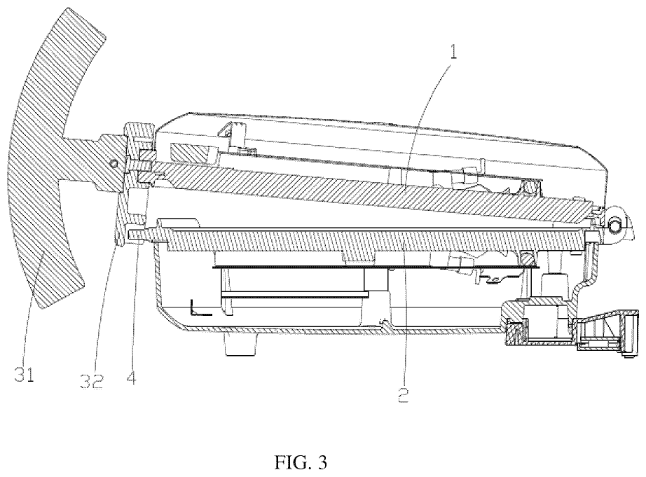

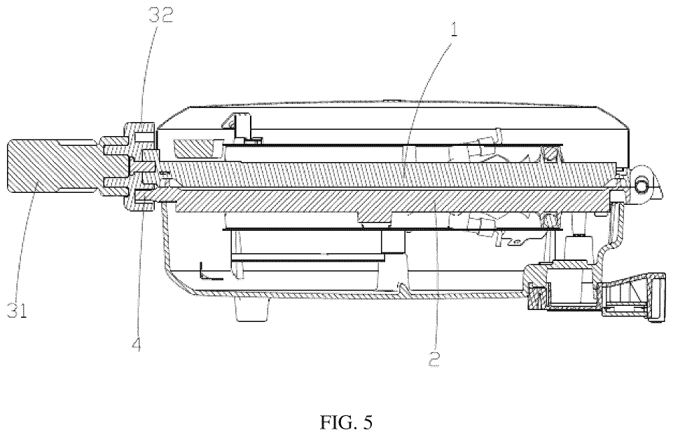

Referring to FIG. 1 to FIG. 6, provided in an embodiment of the present disclosure is a locking device with a flip structure, including a first main body 1 and a second main body 2 in flip connection with the first main body 1, where a rotary control member 3 is arranged on a side edge of the first main body 1; a positioning protruding shaft 4 corresponding to the rotary control member 3 is arranged on a side edge of the second main body 2; a sliding groove 321 configured to fit with the positioning protruding shaft 4 is formed in the rotary control member 3; and when the rotary control member 3 is rotated, a rotational motion of the rotary control member 3 relative to the first main body 1 can be converted into a flip closure motion between the first main body 1 and the second main body 2 through sliding fit between the positioning protruding shaft 4 and the sliding groove 321, until the first main body 1 and the second main body 2 form a tightly closed state. It can be understood that, in this embodiment, the rotary control member 3 and the positioning protruding shaft 4 that fit with each other are arranged between the first main body 1 and the second main body 2 in flip connection; when the first main body 1 and the second main body 2 need to be closed, the rotational motion of the rotary control member 3 relative to the first main body 1 can be converted into the flip closure motion of the first main body 1 relative to the second main body 2 by rotating the rotary control member 3 through the sliding fit between the positioning protruding shaft 4 and the sliding groove 321, until the first main body 1 and the second main body 2 form the tightly closed state and are locked. In a preferred application scenario, the locking device with a flip structure can be applied to a baking pan machine. When relatively firm vegetable or seafood needs to be pan-fried and baked, the first main body 1 is tightly closed against the second main body 2 through rotation of the rotary control member 3 instead of manual pressing, which saves time and labor, and is highly efficient, thereby enhancing user experience.

Referring to FIG. 1, in a preferred embodiment, the rotary control member 3 is rotatably connected to a front side edge of the first main body 1; the positioning protruding shaft 4 is arranged at a front side edge of the second main body 2; the rotary control member 3 and the positioning protruding shaft 4 are arranged oppositely in an up-and-down manner; and rear side edges of the first main body 1 and the second main body 2 are configured to be movably connected through a flip connection structure. In this embodiment, the flip connection structure for the rear side edges of the first main body 1 and the second main body 2 is based on existing conventional technology and will not be repeated herein.

Referring to FIG. 1 to FIG. 6, in a preferred embodiment, the rotary control member 3 includes a rotary handle 31 rotatably connected to the first main body 1; a rotating base 32 opposite to the positioning protruding shaft 4 on the second main body 2 is fixedly connected to the rotary handle 31, the rotating base 32 is configured to rotate synchronously with the rotary handle 31, the sliding groove 321 is formed in an inner side surface of the rotating base 32 corresponding to the positioning protruding shaft 4, and the rotating base 32 is further provided with an opening 322 communicating with the sliding groove 321; and when the first main body 1 flips relative to the second main body 2 to achieve closure, the positioning protruding shaft 4 on the second main body 2 is capable of entering the sliding groove 321 of the rotating base 32 through the opening 322. In a preferred embodiment, preferably, the sliding groove 321 is in the shape of an arc-shaped long strip, and preferably, the positioning protruding shaft 4 and the second main body 2 are of an integrally formed structure. In this embodiment, the bending curvature and extension length of the sliding groove 321 are determined based on the closing dimensions of the first main body 1 and the second main body 2. Specifically, when the rotary handle 31 is turned to move the sliding groove 321 to a stopping position, through guiding and limiting fit between the sliding groove 321 and the positioning protruding shaft 4, the first main body 1 flips relative to the second main body 2 until they are tightly closed together and remain locked.

Referring to FIG. 1, in a preferred embodiment, the rotary control member 3 is configured to be capable of rotating by 90° relative to the first main body 1; during rotation of the rotary control member 3, through the sliding fit between the sliding groove 321 and the positioning protruding shaft 4, the first main body 1 is controlled to flip downward to approach the second main body 2 to achieve closure; and when the rotary control member 3 rotates by 90° relative to the first main body 1, the positioning protruding shaft 4 abuts against a tail end of the sliding groove 321, and the first main body 1 is tightly closed against the second main body 2.

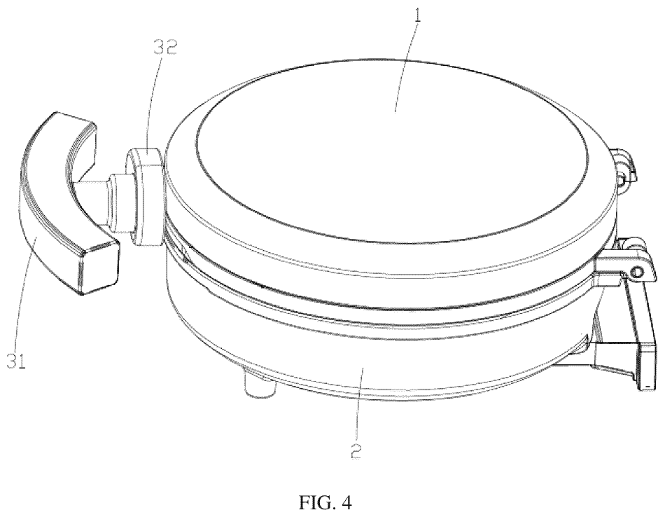

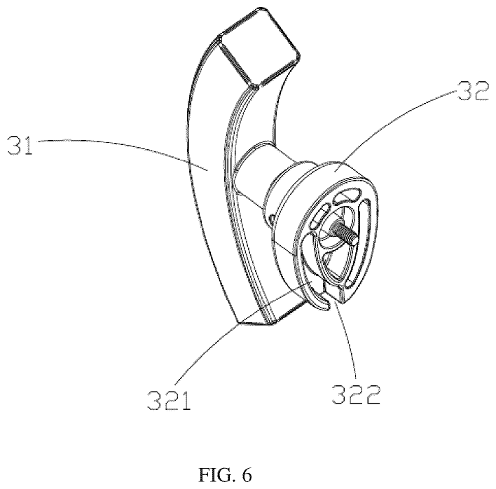

Referring to FIG. 1, FIG. 4, and FIG. 6, in a preferred embodiment, the first main body 1 is an upper baking pan structure of a baking pan machine, and the second main body 2 is a lower baking pan structure of the baking pan machine. However, those skilled in the art should understand that in other embodiments, the first main body 1 may also be the lower baking pan structure of the baking pan machine, and the second main body 2 may be the upper baking pan structure thereof, without being limited to the specific implementations disclosed in this embodiment. In other words, the positions of the rotary control member 3 and the positioning protruding shaft 4 on the first main body 1 and the second main body 2 can be interchanged as needed.

Referring to FIG. 1 to FIG. 6, further provided in an embodiment of the present disclosure is a baking pan machine, including the locking device with a flip structure according to any one of the above embodiments.

The above embodiments are provided solely to illustrate the technical solutions of the present disclosure and are not intended to limit them. Although the present disclosure has been described in detail with reference to the above embodiments, those of ordinary skill in the art should understand that they can still make modifications to the technical solutions described in the above embodiments or make equivalent replacements to some technical features. These modifications or replacements do not make the corresponding technical solutions depart from the spirit and scope of the technical solutions of the embodiments of the present disclosure. Therefore, all other embodiments obtained by those of ordinary skill in the art without creative efforts fall within the scope of protection of the present disclosure.

1. A locking device with a flip structure, comprising a first main body and a second main body in flip connection with the first main body, wherein a rotary control member is arranged on a side edge of the first main body; a positioning protruding shaft corresponding to the rotary control member is arranged on a side edge of the second main body; a sliding groove configured to fit with the positioning protruding shaft is formed in the rotary control member; and when the rotary control member is rotated, a rotational motion of the rotary control member relative to the first main body is converted into a flip closure motion between the first main body and the second main body through sliding fit between the positioning protruding shaft and the sliding groove, until the first main body and the second main body form a closed state.

2. The locking device with a flip structure according to claim 1, wherein the rotary control member is rotatably connected to a front side edge of the first main body; the positioning protruding shaft is arranged at a front side edge of the second main body; the rotary control member and the positioning protruding shaft are arranged oppositely in an up-and-down manner; and rear side edges of the first main body and the second main body are configured to be movably connected through a flip connection structure.

3. The locking device with a flip structure according to claim 1, wherein the rotary control member comprises a rotary handle rotatably connected to the first main body; a rotating base opposite to the positioning protruding shaft on the second main body is fixedly connected to the rotary handle, the rotating base is configured to rotate synchronously with the rotary handle, the sliding groove is formed in an inner side surface of the rotating base corresponding to the positioning protruding shaft, and the rotating base is further provided with an opening in communication with the sliding groove; and when the first main body flips relative to the second main body to achieve closure, the positioning protruding shaft on the second main body is capable of entering the sliding groove of the rotating base through the opening.

4. The locking device with a flip structure according to claim 3, wherein the rotary control member is configured to rotate by 90° relative to the first main body; during rotation of the rotary control member, through the sliding fit between the sliding groove and the positioning protruding shaft, the first main body is controlled to flip downward to approach the second main body to achieve closure; and when the rotary control member rotates by 90° relative to the first main body, the positioning protruding shaft abuts against a tail end of the sliding groove, and the first main body is closed against the second main body.

5. The locking device with a flip structure according to claim 4, wherein the sliding groove is in a shape of an arc-shaped long strip.

6. The locking device with a flip structure according to claim 1, wherein the positioning protruding shaft and the second main body are of an integrally formed structure.

7. The locking device with a flip structure according to claim 1, wherein the first main body is an upper baking pan structure of a baking pan machine, and the second main body is a lower baking pan structure of the baking pan machine.

8. A baking pan machine, comprising the locking device with a flip structure according to claim 1.

9. The baking pan machine according to claim 8, wherein the rotary control member is rotatably connected to a front side edge of the first main body; the positioning protruding shaft is arranged at a front side edge of the second main body; the rotary control member and the positioning protruding shaft are arranged oppositely in an up-and-down manner; and rear side edges of the first main body and the second main body are configured to be movably connected through a flip connection structure.

10. The baking pan machine according to claim 8, wherein the rotary control member comprises a rotary handle rotatably connected to the first main body; a rotating base opposite to the positioning protruding shaft on the second main body is fixedly connected to the rotary handle, the rotating base is configured to rotate synchronously with the rotary handle, the sliding groove is formed in an inner side surface of the rotating base corresponding to the positioning protruding shaft, and the rotating base is further provided with an opening in communication with the sliding groove; and when the first main body flips relative to the second main body to achieve closure, the positioning protruding shaft on the second main body is capable of entering the sliding groove of the rotating base through the opening.

11. The baking pan machine according to claim 10, wherein the rotary control member is configured to rotate by 90° relative to the first main body; during rotation of the rotary control member, through the sliding fit between the sliding groove and the positioning protruding shaft, the first main body is controlled to flip downward to approach the second main body to achieve closure; and when the rotary control member rotates by 90° relative to the first main body, the positioning protruding shaft abuts against a tail end of the sliding groove, and the first main body is closed against the second main body.

12. The baking pan machine according to claim 11, wherein the sliding groove is in a shape of an arc-shaped long strip.

13. The baking pan machine according to claim 8, wherein the positioning protruding shaft and the second main body are of an integrally formed structure.

14. The baking pan machine according to claim 8, wherein the first main body is an upper baking pan structure of the baking pan machine, and the second main body is a lower baking pan structure of the baking pan machine.
